(19) United States
(12) Patent Application Publication
(10) Pub. No.: US 2021/0224040 A1
(43) Pub. Date: Jul. 22, 2021

(54) ARITHMETIC PROCESSING APPARATUS AND CONTROL METHOD FOR ARITHMETIC PROCESSING APPARATUS

(71) Applicant: FUJITSU LIMITED, Kawasaki-shi (JP)

(72) Inventors: Takeshi Osonoi, Kawasaki (JP); HIROYUKI WADA, Kawasaki (JP)

(73) Assignee: FUJITSU LIMITED, Kawasaki-shi (JP)

(21) Appl. No.: 17/224,164

(22) Filed: Apr. 7, 2021

Related U.S. Application Data
(63) Continuation of application No. PCT/JP2018/038830, filed on Oct. 18, 2018.

(51) Int. Cl. G06F 7/552; G06F 7/556; G06F 7/535

(52) U.S. Cl. CPC G06F 7/552; G06F 7/535; G06F 7/556

(57) ABSTRACT

An arithmetic processing apparatus computes a square root of a radicand and includes: a memory; and a processor coupled to the memory and configured to: determine a part of a bit string of a quotient; calculate a first partial remainder based on the bit string and a partial remainder by performing a first operation other than an exponentiation operation in a partial remainder operation; and calculate the partial remainder by performing a second operation that includes the exponentiation operation, using the first partial remainder and the bit string.

### CROSS-REFERENCE TO RELATED APPLICATION

This application is a continuation application of International Application PCT/JP2018/038830 filed on Oct. 18, 2018 and designated the U.S., the entire contents of which are incorporated herein by reference.

### FIELD

The embodiment relates to an arithmetic processing unit and a control method for the arithmetic processing unit.

### BACKGROUND

In recent years, the practical application of deep learning technique has been progressing in diverse fields, and a processor for the purpose of deep learning is required. While batch normalization is used to enhance training speed in deep learning, square root extraction operation is necessary for this batch normalization. Therefore, processors for the purpose of deep learning are required to execute the square root extraction operation at high speed.

Related art is disclosed in Japanese Laid-open Patent Publication No. 09-269892 and Japanese Laid-open Patent Publication No. 11-353158.

### SUMMARY

According to an aspect of the embodiments, an arithmetic processing apparatus computes a square root of a radicand and includes: a memory; and a processor coupled to the memory and configured to: determine a part of a bit string of a quotient; calculate a first partial remainder based on the bit string and a partial remainder by performing a first operation other than an exponentiation operation in a partial remainder operation; and calculate the partial remainder by performing a second operation that includes the exponentiation operation, using the first partial remainder and the bit string.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a square root extraction operation circuit as an example of an embodiment.

FIG. 2 is a flowchart for describing a process of the square root extraction operation circuit as an example of the embodiment.

FIG. 3 is a diagram illustrating a configuration in which the square root extraction operation circuit as an example of the embodiment is adapted to input and output of floating-point numbers.

FIG. 4 is a flowchart for describing a process of an operation circuit including the square root extraction operation circuit as an example of the embodiment.

FIG. 5 is a diagram illustrating a configuration of an operation circuit as a modification of the operation circuit illustrated in FIG. 3.

FIG. 6 is a diagram illustrating an initial value determination logic by an initial value determination circuit of the operation circuit as the modification of the embodiment.

FIG. 7 is a flowchart for describing a process of the operation circuit including a square root extraction operation circuit as the modification of the embodiment.

FIG. 8 is a diagram illustrating a configuration of a conventional square root extraction operation circuit.

### DESCRIPTION OF EMBODIMENTS

The Sweeney, Robertson, Tocher (SRT) method and the non-restoring method are known as general algorithms for implementing the square root extraction operation in hardware. In the square root extraction operation based on these methods, x=Q\hat{ }2+R is set for a radicand x, and the addition and subtraction of Q and R is repeated while this formula is satisfied. Here, Q denotes a partial quotient (a result of square root extraction halfway), and R indicates a partial remainder. When R is made close enough to 0, Q obtains a value close enough to a square root sqrt(x) of x.

When the above formula is expressed by a recurrence formula, following formula (1) is given.

Qᵢ₊₁\hat{ }2+Rᵢ₊₁=Qᵢ\hat{ }2+Rᵢ (1)

By transforming above formula (1), following formula (2) is worked out.

$$\begin{matrix}{R}_{i + 1} = {R}_{i} - {Q}_{i + 1} \hat{} 2 + {Q}_{i} \hat{} 2 \\ = {R}_{i} - ( {Q}_{i} + {q}_{i} ) \hat{} 2 + {Q}_{i} \hat{} 2 \\ = {R}_{i} - 2 {Q}_{i} * {q}_{i} - {q}_{i} \hat{} 2\end{matrix} \qquad ( 2 )$$

The meaning of each variable is as follows.

Rᵢ: Partial remainder of the i-th operation. R₀=x.

Qᵢ: Partial quotient of the i-th operation. Q₀=0.

qᵢ: Part of the bit string of the quotient worked out in the i-th operation. Qᵢ+qᵢ=Qᵢ₊₁.

The variable qᵢ starts from the most significant bit of the quotient. Each time i is incremented by one, the digits of qᵢ are moved to a low-order end by the number of bits of the quotient worked out in one operation, and a plurality of candidates such as candidates that are integral multiples of the digits are prepared.

For example, in the case of the SRT method of radix-4, which works out two bits of the quotient in one operation, following formula (3) is given.

qᵢ=(−3 or −2 or −1 or 0 or +1 or +2 or +3)*2\hat{ }−2i (3)

In above formula (2), Qᵢ₊₁ approaches sqrt(x) by determining qᵢ such that Rᵢ₊₁ is made closer to 0.

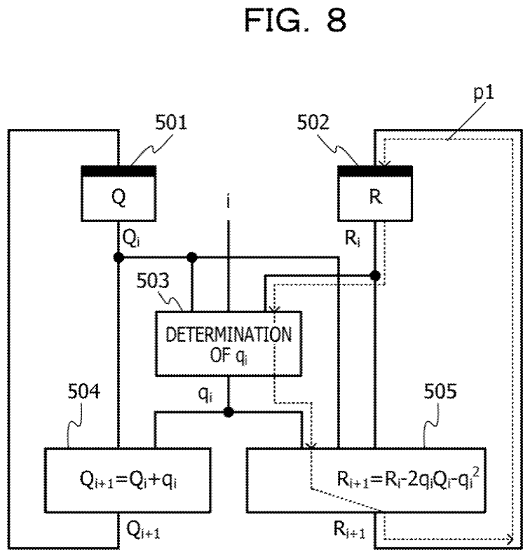

FIG. 8 is a diagram illustrating a configuration of a conventional square root extraction operation circuit, and illustrates an example in which above formula (2) is implemented on a digital circuit.

The operation circuit illustrated in FIG. 8 is a square root extraction operation circuit that performs square root extraction operation, and includes registers 501 and 502, and logic circuits 503, 504, and 505.

The register 501 is connected to the logic circuits 503, 504, and 505, and the register 502 is connected to the logic circuits 503 and 505. The register 501 is initialized with 0, and the register 502 is initialized with x.

A register value Qᵢ read from the register 501 is input to each of the logic circuits 503, 504, and 505, and a register value Rᵢ read from the register 502 is input to each of the logic circuits 503 and 505. Hereinafter, the register value Qᵢ read from the register 501 is sometimes referred to as an output Qᵢ of the register 501. Similarly, hereinafter, the register value Rᵢ read from the register 502 is sometimes referred to as an output Rᵢ of the register 502.

The logic circuit 503 is connected to each of the registers 501 and 502 and the logic circuits 504 and 505, and receives inputs of the output Qᵢ of the register 501, the output Rᵢ of the register 502, and an operation count signal i.

The logic circuit 503 determines qᵢ based on the output Qᵢ of the register 501, the output Rᵢ of the register 502, and the operation count signal i. That is, the logic circuit 503 selects qᵢ from among candidates indicated in formula (3) such that Rᵢ₊₁ approaches 0 in above formula (2).

The logic circuit 503 inputs the determined qᵢ to each of the logic circuits 504 and 505. The logic circuit 504 receives Qᵢ and qᵢ to perform the operation of Qᵢ₊₁=Qᵢ+qᵢ, and outputs Qᵢ₊₁. This output Qᵢ₊₁ of the logic circuit 504 is input to the register 501 to update the value of this register 501.

The logic circuit 505 receives R₁, Qᵢ, and qᵢ, to perform the operation of above formula (2), and outputs Rᵢ₊₁. This output Rᵢ₊₁ of the logic circuit 505 is input to the register 502 to update the value of this register 502.

By repeating the operations by the logic circuits 503 to 505 for a plurality of cycles, Qᵢ approaches sqrt(x). The operations are repeated until the required number of digits of Qᵢ is worked out as the operation result, and thereafter Qᵢ is output as the operation result.

In the conventional square root extraction operation circuit illustrated in FIG. 8, a path p1 (see FIG. 8) that returns to the register 502 from the register 502 via the logic circuits 503 and 505 is a critical path in terms of delay.

In the square root extraction operation circuit, it is required to improve such a delay in the critical path.

In one aspect, the delay in the critical path in the square root extraction operation circuit may be improved.

Hereinafter, an embodiment relating to present arithmetic processing unit and control method for the arithmetic processing unit will be described with reference to the drawings. However, the embodiment to be described below is merely an example, and there is no intention to exclude application of various modifications and techniques not explicitly described in the embodiment. That is, the present embodiment can be variously modified (combining the embodiment and each of modifications, for example) without departing from the spirit of the present embodiment. Furthermore, each drawing is not intended to include only the constituent elements illustrated in the drawing, and may include other functions and the like.

### (I) Description of One Embodiment

(A) Configuration

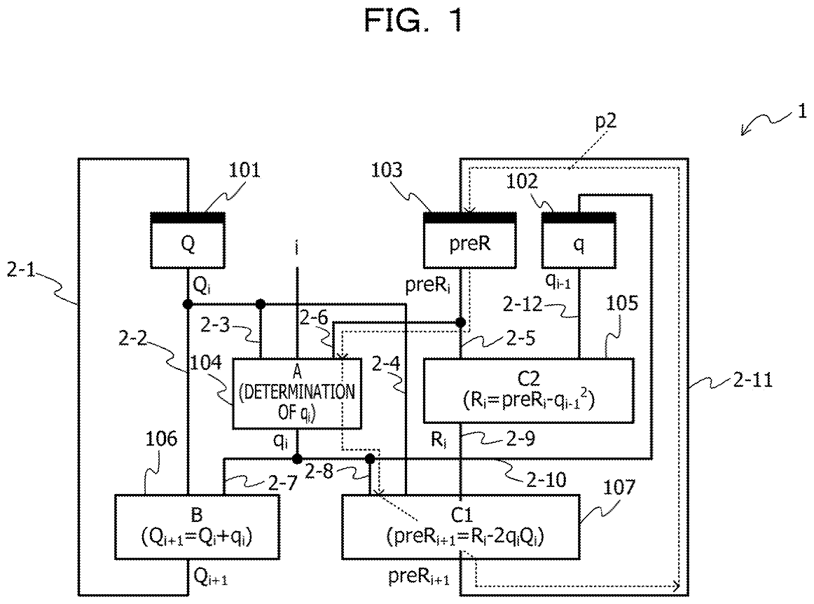

FIG. 1 is a diagram illustrating a configuration of a square root extraction operation circuit 1 as an example of an embodiment.

The square root extraction operation circuit 1 is an operation circuit that performs a square root extraction operation, and performs the operation of sqrt(x) of a radicand x based on the SRT method or the non-restoring method.

In the square root extraction operation based on the SRT method or the non-restoring method, x=Q\hat{ }2+R is set for the radicand x, and the addition and subtraction of Q and R is repeated while this formula is satisfied. Q denotes a partial quotient (a result of square root extraction halfway), and R indicates a partial remainder. When R is made close enough to 0, Q obtains a value close enough to the square root sqrt(x) of x.

The square root extraction operation circuit 1 illustrated in FIG. 1 includes registers 101 to 103 and logic circuits 104 to 107. Hereinafter, the register 101 is sometimes referred to as a register Q. Similarly, the register 162 is sometimes referred to as a register q, and the register 103 is sometimes referred to as a register preR.

The register 101 is connected to each of the logic circuits 106, 104, and 107 via paths (communication routes) 2-2, 2-3, and 2-4. A register value Q read from the register 101 is input to each of the logic circuits 104, 106, and 107. Hereinafter, the register value Qᵢ read from the register 101 is sometimes referred to as an output Qᵢ of the register 101.

The register 103 is connected to each of the logic circuits 104 and 105 via paths 2-6 and 2-5. A register value preRᵢ read from the register 103 is input to each of the logic circuits 104 and 105. Hereinafter, the register value p_{reRi} read from the register 103 is sometimes referred to as an output p_{reRi} of the register 103.

The register 102 is connected to the logic circuit 105 via a path 2-12. A register value qᵢ₋₁ read from the register 102 is input to the logic circuit 105. Hereinafter, the register value qᵢ₋₁ read from the register 102 is sometimes referred to as an output qᵢ₋₁ of the register 102.

In the present square root extraction operation circuit 1, operations by the logic circuits 104 to 107, which will be described later, are repeated until a required number of bits of the quotient is reached (loop operations).

The logic circuit 104 is connected to the registers 101 and 103, and is also connected to each the logic circuits 106 and 107, and the register 102 via paths 2-7, 2-8, and 2-10. The output Qᵢ of the register 101, the output preR of the register 103, and a signal (operation count signal) i indicating the number of operations are input to the logic circuit 104. Furthermore, hereinafter, i is sometimes used also as a value indicating the number of operations.

The logic circuit 104 functions as a first logic circuit that determines a part of the bit string (partial quotient bit string) qᵢ of a quotient worked out at the i-th operation, based on the output Qᵢ of the register 101, the output preR of the register 103, and the number of operations i.

Incidentally, in the SRT method and the non-restoring method, the partial quotient bit string qᵢ is designated by verifying the partial quotient Qᵢ and the partial remainder Rᵢ. As characteristics of these algorithms, a valid solution can be obtained not only when verification is made by strict values of Qᵢ and Rᵢ, but also when verification is made by values containing errors with respect to Qᵢ and Rᵢ to some extent.

Focusing on the logic circuit 505 in the conventional square root extraction operation circuit illustrated in FIG. 8, in above formula (2), as i increases, the term of qᵢ\hat{ }2 relatively becomes small as compared with the terms of Rᵢ and 2qᵢ*Qᵢ.

From the above, after i has become large to some extent, there is no difficulty in the action of the logic circuit 503 even if the term qᵢ\hat{ }2 in formula (2) is excluded. This means that a change can be made such that above formula (2) is replaced with following formula (4) and an output preRᵢ₊₁ of the formula is used in the logic circuit 503.

preRᵢ₊₁=Rᵢ−2Qᵢ*qᵢ (4)

However, while i is small, the term of qᵢ\hat{ }2 is relatively large, and the difference between Rᵢ₊₁ in above formula (2) and preRᵢ₊₁ in formula (4) is large. Accordingly, simply replacing Rᵢ with preRᵢ sometimes does not work out a valid solution.

This is because Rᵢ needs to be made close to 0 in the i-th operation to an extent that R can converge to 0 by the i+1-th and following operations, but while i is small, appropriate qᵢ cannot be selected by the logic circuit and Rᵢ does not approach 0 enough in some cases. In the present square root extraction operation circuit 1, in order to avoid this difficulty, an approach of mitigating the amount of movement of the digits of qᵢ to a low-order end with respect to an increase in i is used while i is small (when i is equal to or less than a predetermined threshold value k).

For example, in the case of the SRT method of radix-4, qᵢ is defined using following formula (5) in the logic circuit 104.

$$\begin{matrix} [ Mathematical Formula 1 ] & \\ \begin{matrix}When i \leq k Holds , \\ {q}_{i} = ( - 3 or - 2 or - 1 or 0 or + 1 or + 2 or + 3 ) * 2 * i \\ \begin{matrix}When i > k Holds , \\ {q}_{i} = ( - 3 or - 2 or - 1 or 0 or + 1 or + 2 or + 3 ) * 2 * ( 2 i - k )\end{matrix}\end{matrix} \} \\ k is integral constant . & ( 5 )\end{matrix}$$

When i≤k holds, qᵢ is larger than formula (3). Accordingly, even if Rᵢ does not approach 0 in one operation as much as necessary when formula (2) is employed, it becomes possible to converge Rᵢ to 0 in following operations.

In the present square root extraction operation circuit 1, one bit of solution is worked out per cycle while i is equal to or less than the threshold value k, and two bits of solution are worked out per cycle after i has become larger than the threshold value k.

In the square root extraction operation circuit 1 illustrated in FIG. 1, the logic circuit 104 selects qᵢ from among candidates indicated in formula (5) such that Rᵢ₊₁ approaches 0 in formula (4).

The value qᵢ determined by the logic circuit 104 is input to each of the logic circuit 106 via the path 2-7, the logic circuit 107 via the path 2-8, and the register 102 via the path 2-10.

In the logic circuit 106, Qᵢ is input from the register 101 via the path 2-2 and qᵢ is input from the logic circuit 104 via the path 2-7, individually.

The logic circuit 106 receives Qᵢ and qᵢ to perform the operation of Qᵢ₊₁=Qᵢ+qᵢ, and outputs Qᵢ₊₁. The logic circuit 106 is connected to the register 101 via a path 2-1, and the output Qᵢ₊₁ of the logic circuit 106 is input to the register 101 via this path 2-1 to update the value of this register 101.

The logic circuit 105 performs the operation of the term of qᵢ\hat{ }2 excluded in above formula (4). The value q, determined by the logic circuit 104 is stored in the register 102 via the path 2-10 and temporarily held, and then input to the logic circuit 105 in the next cycle as a value qᵢ₋₁ of the preceding cycle. Furthermore, preRᵢ of the register 103 is also input to the logic circuit 105 via the path 2-5.

While qᵢ determined by the logic circuit 104 is input to the logic circuits 106 and 107, qᵢ₋₁ at a cycle immediately preceding the cycle of qᵢ input to these logic circuits 106 and 107 is input to the logic circuit 105.

The logic circuit 105 receives preRᵢ of the register 103 and qᵢ₋₁ of the register 102 to perform the operation of following formula (6), and outputs Rᵢ.

Rᵢ=preRᵢ−qᵢ₋₁\hat{ }2 (6)

The logic circuit 105 functions as a third logic circuit that performs a second operation (formula (6)) including an exponentiation operation (qᵢ₋₁\hat{ }2), using a first partial remainder (preRᵢ) and a bit string (qᵢ) to calculate a partial remainder (Rᵢ).

The logic circuit 105 is connected to the logic circuit 107 via a path 2-9, and the output Rᵢ of the logic circuit 105 is input to the logic circuit 107 via this path 2-9.

The logic circuit 107 is connected to each of the logic circuit 104 via the path 2-8, the register 101 via the path 2-4, the logic circuit 105 via the path 2-9, and the register 103 via a path 2-11.

The logic circuit 107 performs the operation of above formula (4) based on qᵢ output from the logic circuit 104, Rᵢ output from the logic circuit 105, and Qi read from the register 101, and outputs preRᵢ₊₁. This output preRᵢ₊₁ of the logic circuit 107 is input to the register 103 via the path 2-11 to update the value of this register 103.

Mat is, the logic circuit 107 functions as a second logic circuit that calculates a first partial remainder (preRᵢ) based on the bit string (qᵢ) and the partial remainder (Ri) by performing a first operation (formula (4)) other than the exponentiation operation (qᵢ₋₁\hat{ }2) in a partial remainder operation.

In the present square root extraction operation circuit 1, the logic circuit 105 is arranged between the register 103 and the logic circuit 107 so as to be in parallel with the logic circuit 104, with respect to the path (a critical path in terms of delay) that links the register 103, the path 2-6, the logic circuit 104, the path 2-8, the logic circuit 107, and the path 2-11. Furthermore, the logic circuit 105 is connected in series with the logic circuit 107 at a position on an upstream side of the logic circuit 107.

Then, the logic circuit 105 is provided away from the critical path in terms of delay in the present square root extraction operation circuit 1 (see p2 in FIG. 1), and is not included in the critical path, That is, in the present square root extraction operation circuit 1, the logic circuit 105 that performs the operation of the term of qi\hat{ }2 is provided outside the critical path in terms of delay.

In the present square root extraction operation circuit 1, Q approaches sqrt(x) by repeating the operations by the logic circuits 104 to 107 for a plurality of cycles. The operations are repeated until the required number of digits of Qᵢ is worked out as the operation result, and thereafter Qᵢ is output as the operation result.

(B) Action

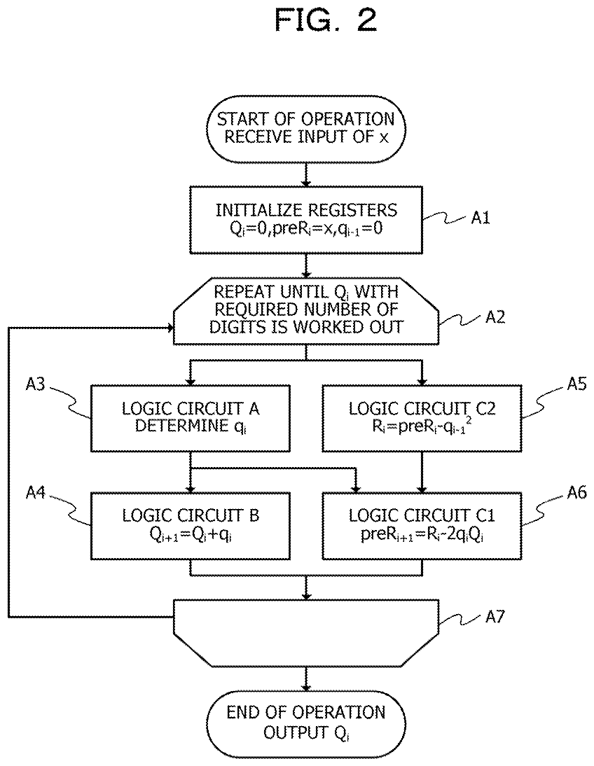

The process of the square root extraction operation circuit 1 as an example of the embodiment configured as described above will be described with reference to the flowchart (steps A1 to A7) illustrated in FIG. 2.

In step A1, the registers 101 to 103 are initialized. The initialization of the registers 101 to 103 may be performed by, for example, a control device (not illustrated) located outside the square root extraction operation circuit 1.

By initializing each of the registers 101 to 103, the register value Qᵢ=0 of the register 101, the register value qᵢ₋₁=0 of the register 102, and the register value preRᵢ=x of the register 103 are given.

In step A2, a loop process is started in which the control up to step A7 is repeatedly carried out until Qᵢ with the required number of digits is worked out in the square root extraction operation of the processing target.

The output Qᵢ of the register Q (register 101), the output preRᵢ of a register preR (register 103), and the number of operations i are input to a logic circuit A (logic circuit 104).

In step A3, the logic circuit A performs the operation of above formula (5) based on input Qᵢ, preRᵢ and i to determine qᵢ, and outputs determined qᵢ.

The output Qᵢ of the register Q (register 101) and the output qᵢ of the logic circuit A (logic circuit 104) are input to a logic circuit B (106).

In step A4, the logic circuit B performs the operation of Qᵢ₊₁=Qᵢ+qᵢ based on Qᵢ and qᵢ, and outputs Qᵢ₊₁. Output Qᵢ₊₁ is input to the register Q to update the register value of this register Q.

Meanwhile, qᵢ determined by the logic circuit A is temporarily held in the register q (register 102), and then input to a logic circuit C2 (logic circuit 105) as qᵢ₋₁ in the next cycle. Furthermore, the output preRᵢ of the register preR (register 103) is also input to the logic circuit C2 (logic circuit 105).

In step A5, the logic circuit C2 performs the operation of formula (6) based on preRᵢ and qᵢ₋₁, and outputs Rᵢ.

Rᵢ output from the logic circuit C2, qᵢ output from the logic circuit A, and the output Qᵢ of the register Q are input to a logic circuit C1 (logic circuit 107).

In step A6, the logic circuit 107 performs the operation of above formula (4) based on qᵢ, Rᵢ, and Qᵢ, and outputs preRᵢ₊₁.

Thereafter, the control advances to step A7. In step A7, a loop end process corresponding to step A2 is carried out. Here, when the required number of digits of Qᵢ is worked out, the arithmetic process by the present square root extraction operation circuit 1 is ended. Calculated Qᵢ is output to a subsequent processing unit (for example, another operation circuit).

(C) Effects

As described above, according to the square root extraction operation circuit 1 as an example of the embodiment, the logic circuit 105 performs the operation of the term of qᵢ\hat{ }2 by performing the operation of formula (6). This eliminates the necessity to perform the operation of qᵢ\hat{ }2 in the logic circuit 107 and enables the reduction of the number of logic stages of the logic circuit 107. Consequently, the delay in the logic circuit 107 can be reduced.

In the present square root extraction operation circuit 1, the path p2 (see FIG. 1) that returns to the register 103 from the register 103 via the logic circuits 104 and 107 is a critical path in terms of delay.

Then, since the logic circuit 107 can be configured with a small number of logic stages and the delay can be shortened, the total delay in the critical path p2 of the operation circuit 1 can be made shorter. That is, the total delay in the critical path p2 of the present square root extraction operation circuit 1 can be made short as compared with the critical path p1 of the conventional square root extraction operation circuit illustrated in FIG. 8, and the improvement of the critical path can be achieved.

The present square root extraction operation circuit 1 can improve the delay in the critical path when performing the square root extraction operation based on the SRT method or the non-restoring method.

(II) Application to Operation Circuit

(A) Configuration

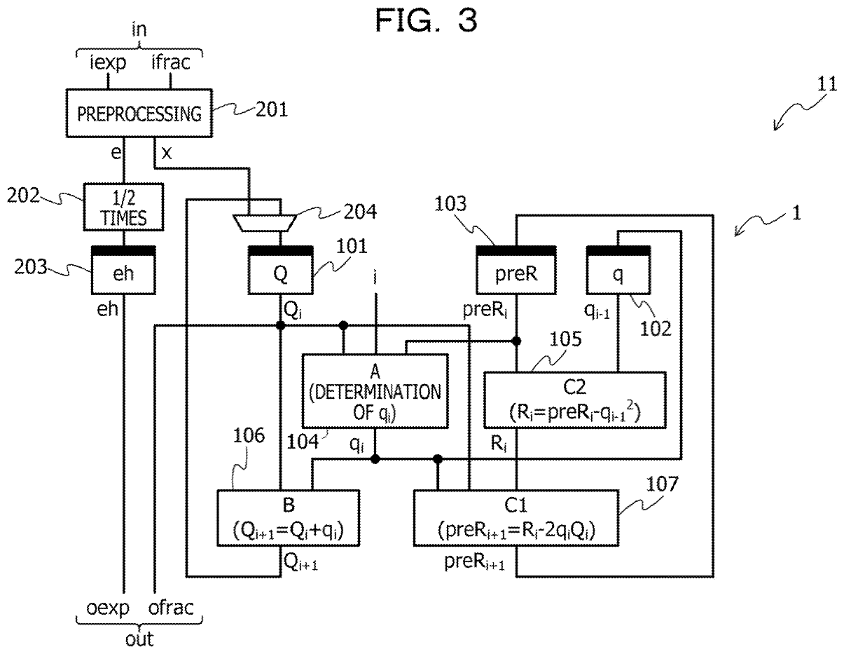

FIG. 3 illustrates a configuration in which the square root extraction operation circuit 1 of the above-described embodiment is adapted with input and output of floating-point numbers.

Note that, in the drawing, similar parts to the aforementioned parts are denoted by the same reference signs as those of the aforementioned parts, and thus the description thereof will be omitted. Furthermore, in FIG. 3, the illustration of the reference signs of the paths illustrated in FIG. 1 is omitted.

An operation circuit 11 illustrated in FIG. 3 includes a preprocessing circuit 201, a ½-time circuit 202, a register 203, and a selector 204, in addition to the square root extraction operation circuit 1 illustrated in FIG. 1.

For a floating-point number in, this operation circuit 11 illustrated in FIG. 3 works out a floating-point number out of a square root of in.

It is assumed that in and out include exponential parts iexp and oexp and mantissa parts ifrac and ofrac as illustrated in following formulas (7) and (8). The exponential parts iexp and oexp are integers, and the mantissa parts ifrac and ofrac are real numbers equal to or greater than 1 but less than 2.

in=2\hat{ }i exp*ifrac (7)

out=2\hat{ }o exp*ofrac (8)

In the present square root extraction operation circuit 1, a corrected exponential part e and a corrected mantissa part x are generated based on iexp and ifrac, and out is generated based on these e and x. Above-mentioned in and e and x have the relationship of following formula (9).

in=2\hat{ }e*x (9)

These e and x are designated by following formulas (10) and (11).

When i exp is an even number, e=i exp, x=ifrac (10)

When i exp is an odd number, e=iexp−1, x=ifrac*2 (11)

From above formula (9), the square root of in can be worked out by following formula (12). In the formula, eh=e/2 holds.

sqrt(in)=2\hat{ }eh*sqrt(x) (12)

From above formulas (10) and (11), e necessarily has an even number, and thus eh is given as an integer. Furthermore, since x is a real number equal to or greater than 1 but less than 4, sqrt(x) is given as a real number equal to or greater than 1 but less than 2. Therefore, comparing above formulas (8) and (12), it can be seen that oexp=eh and ofrac=sqrt(x) hold, and out can be worked out by performing the operation of eh and sqrt(x).

The floating-point number in (iexp, ifrac) is input to the preprocessing circuit 201. The preprocessing circuit 201 calculates (generates) the corrected exponential part e and the corrected mantissa part x based on above formulas (10) and (11), using input in (iexp, ifrac).

Calculated e is input to the ½-time circuit 202. The ½-time circuit 202 multiplies input e by ½ and outputs multiplied e as eh (eh=e/2). Note that the ½-time circuit 202 achieves the multiplication of e by ½ by shifting e to the right by one bit. Output eh is input to the register 203. A register value eh read from the register 203 is output as oexp.

The register value eh read from the register 203 may be referred to as an output eh of the register 203.

The mantissa part x output from the preprocessing circuit 201 is input to the selector 204. The selector 204 selects the output x of the preprocessing circuit 201 only when the register 101 is initialized, and selects the output of the logic circuit 106 otherwise to output the selected output.

That is, x output from the preprocessing circuit 201 is input to the register 101 after passing through the selector 204.

After x is input to the register 101, the square root extraction operation circuit 1 performs the operation of sqrt(x). Note that the operation of sqrt(x) by the square root extraction operation circuit 1 is similar to the process described above with reference to FIGS. 1 and 2, and thus the description thereof will be omitted. When the square root extraction operation circuit 1 completes the operation of sqrt(x), Qᵢ becomes sqrt(x) and Qᵢ is output as ofrac.

(B) Action

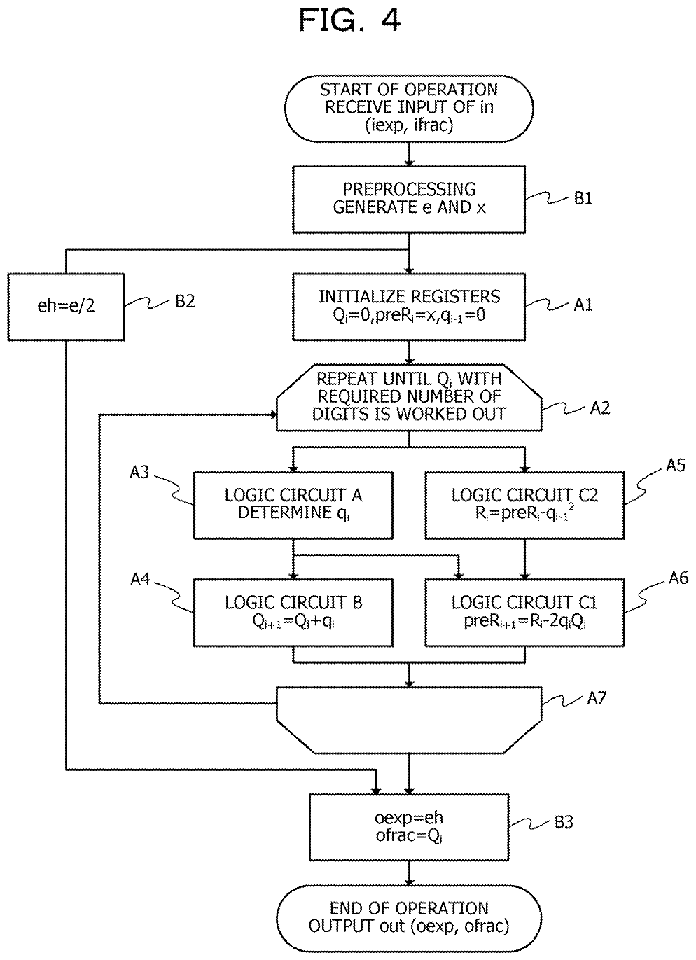

The process of the operation circuit 11 including the square root extraction operation circuit 1 as an example of the embodiment configured as described above will be described with reference to the flowchart (steps A1 to A7, B1 to B3) illustrated in FIG. 4.

Note that, in the drawing, similar processes to the aforementioned processes are denoted by the same reference signs as those of the aforementioned processes, and thus the description thereof will be omitted.

When the operation is started, for example, in (iexp, ifrac) is input from a control device (not illustrated) located outside the square root extraction operation circuit 1.

In step B1, the preprocessing circuit 201 calculates (generates) the corrected exponential part e and the corrected mantissa part x based on above formulas (10) and (11), using input in (iexp, ifrac). Calculated e is input to the ½-time circuit 202.

In step B2, the ½-time circuit 202 multiplies input e by ½ and outputs multiplied e as eh (eh=e/2). Thereafter, the process proceeds to step B3.

Furthermore, x calculated by the preprocessing circuit 201 is input to the selector 204. At the time of initializing the register 101, the selector 204 employs the output x of the preprocessing circuit 201 to input to the register 101. Thereafter, the process proceeds to step A1. After the processes in steps A1 to A7 are completed, the process proceeds to step B3.

In step B3, Qᵢ is output as ofrac and eh is output as oexp. That out (oexp, ofrac) is output and the process ends. Output out is output to a subsequent processing unit (for example, another operation circuit).

(C) Effects

As described above, according to the operation circuit 11, since the square root extraction operation circuit 1 is included, similar action effects to those of the above-described embodiment can be exhausted. That is, the delay in the critical path when the square root extraction operation is performed based on the SRT method or the non-restoring method can be improved.

(III) Modification of Application to Operation Circuit

(A) Configuration

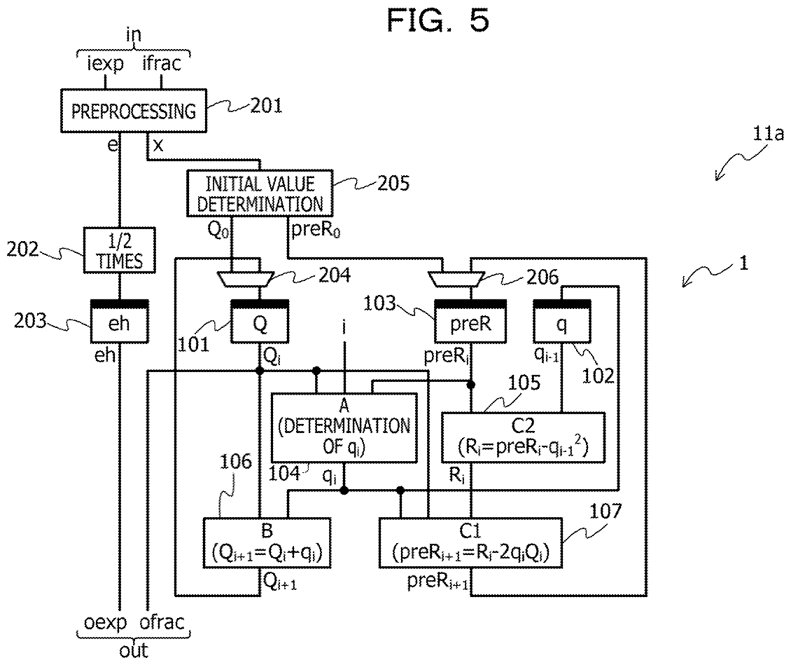

FIG. 5 is a diagram illustrating a configuration of an operation circuit 11a as a modification of the operation circuit 11 illustrated in FIG. 3. Note that, in the drawing, similar parts to the aforementioned parts are denoted by the same reference signs as those of the aforementioned parts, and thus the description thereof will be omitted. Furthermore, in FIG. 5, the illustration of the reference signs of the paths illustrated in FIG. 1 is omitted.

The operation circuit 11a has a configuration for speeding up the solution derivation of the operation circuit illustrated in FIG. 3.

In the square root extraction operation circuit 1 illustrated in FIG. 1, as a workaround for the difficulty that Rᵢ converges slowly while i is small, the digits of qᵢ are moved to a low-order end by one bit at a time (the solution is derived by one bit at a time) while i is equal to or less than the threshold value k, and after i has become larger than the threshold value k, the digits are moved to a low-order end by two bits at a time (the solution is derived by two bits at a time), as indicated by formula (5).

That is, in the square root extraction operation circuit 1 illustrated in FIG. 1, one bit of solution is worked out per cycle while i is equal to or less than the threshold value k, and two bits of solution are worked out per cycle after i has become larger than the threshold value k.

In contrast to this, in the present operation circuit 11a, two bits are always worked out per cycle regardless of i. This can make the latency in the solution derivation in the present operation circuit 11a shorter.

As illustrated in FIG. 5, the operation circuit 11a includes an initial value determination circuit 205 and a selector 206, in addition to the operation circuit 11 illustrated in FIG. 3.

The corrected mantissa part x output from the preprocessing circuit 201 is input to the initial value determination circuit 205. The initial value determination circuit 205 determines an initial value Q₀ of the partial quotient based on x input from the preprocessing circuit 201.

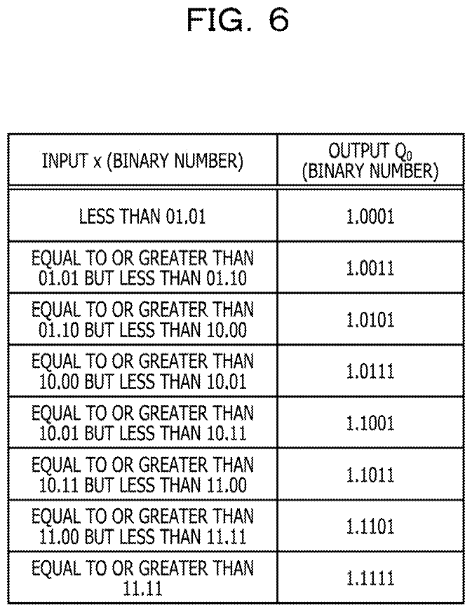

FIG. 6 is a diagram illustrating an initial value determination logic by the initial value determination circuit 205 of the operation circuit 11a as the modification of the embodiment.

This FIG. 6 illustrates a configuration in which the input x (corrected mantissa part) and the output Q₀ (the initial value of the partial quotient) are associated with each other. Note that, in the example illustrated in FIG. 6, the input x and the output Q₀ are represented by binary numbers.

The initial value determination circuit 205 determines the output Q₀ corresponding to the input value of x, for example, with reference to this determination logic illustrated in FIG. 6. For example, when the input x=10.10 is given, the initial value determination circuit 205 determines the output Q0=1.1001 and outputs the determined output.

In the present operation circuit 11, the initial value Q₀ of Qᵢ is finely classified according to the high-order bits of x, and a few high-order bits of Qᵢ are defined at the time of initialization. This makes it possible to begin the determination of qᵢ with a bit following the few high-order bits.

Since qᵢ begins from the low-order bit, the above-mentioned difficulty that the term of qᵢ\hat{ }2 is relatively small even when i is small in above formula (4) and Rᵢ converges slowly while i is small can be avoided, and the solution can be derived by two bits at a time regardless of i.

Note that the function corresponding to the determination logic illustrated in FIG. 6 may be achieved by, for example, information stored in a storage device (a register or the like) (not illustrated), and can be variously modified.

Furthermore, the determination logic referred to by the initial value determination circuit 205 is not limited to the one illustrated in FIG. 6, and can be appropriately changed.

Q₀ output from the initial value determination circuit 205 is input to the selector 204.

Furthermore, the initial value determination circuit 205 determines (generates) preR₀ by performing the operation of following formula (13) based on x and Q₀.

preR₀=x−Q₀\hat{ }2 Formula (13)

Above-mentioned preR₀ determined by the initial value determination circuit 205 is input to the register 103 (register preR) via the selector 206.

Q₀ output from the initial value determination circuit 205 is input to the selector 204. The selector 204 selects the output Q₀ of the initial value determination circuit 205 only when the register 101 is initialized, and selects the output of the logic circuit 106 otherwise to output the selected output.

The selector 206 selects the output preR₀ of the initial value determination circuit 205 only when the register 103 is initialized, and selects the output of the logic circuit 107 otherwise to output the selected output.

(B) Action

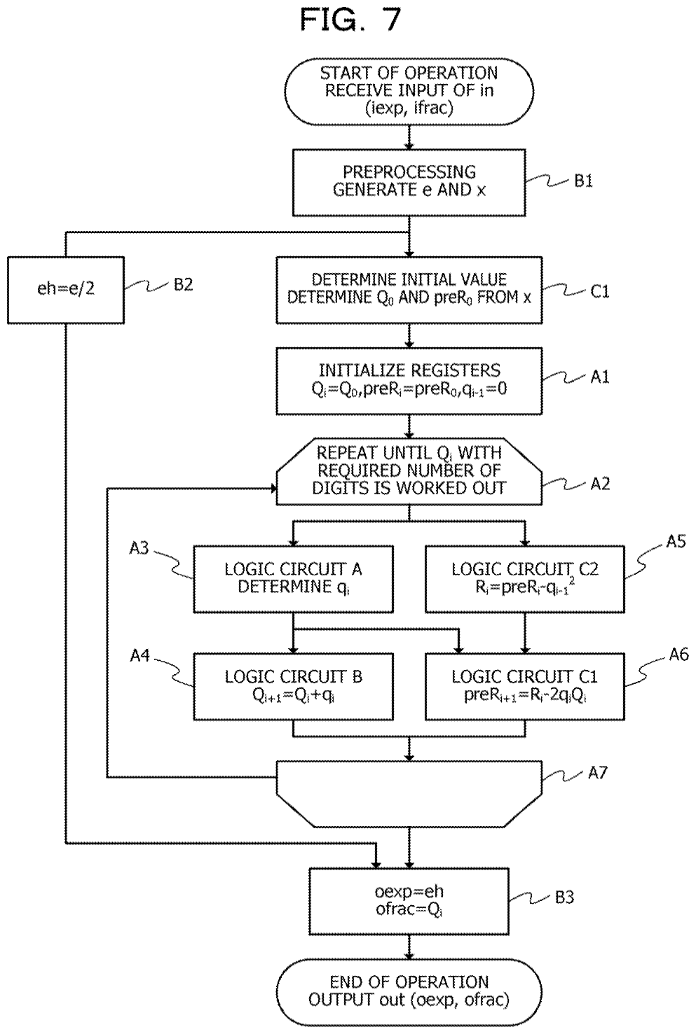

The process of the operation circuit 11a as a modification of the embodiment configured as described above will be described with reference to the flowchart (steps A1 to A7, B1 to B3, C1) illustrated in FIG. 7.

Note that, in the drawing, similar processes to the aforementioned processes are denoted by the same reference signs as those of the aforementioned processes, and thus the description thereof will be omitted.

When the operation is started, for example, in (iexp, ifrac) is input from a control device (not illustrated) located outside the square root extraction operation circuit 1.

In step B1, the preprocessing circuit 201 calculates (generates) the corrected exponential part e and the corrected mantissa part x based on above formulas (10) and (11), using input in (iexp, ifrac). Calculated e is input to the ½-time circuit 202.

Above-mentioned x calculated by the preprocessing circuit 201 is input to the initial value determination circuit 205. The initial value determination circuit 205 determines the initial value Q₀ of the partial quotient based on x input from the preprocessing circuit 201.

In step C1, the initial value determination circuit 205 determines (generates) preR₀ by performing the operation of above formula (13) based on x and Q₀.

At the time of initializing the register 101, the selector 204 employs the output Q₀ of the initial value determination circuit 205 to input to the register 101. Furthermore, at the time of initializing the register 103, the selector 206 employs the output preR₀ of the initial value determination circuit 205 to input to the register 103. Thereafter, the process proceeds to step A1.

After the processes in steps A1 to A7 are completed, the process proceeds to step B3. In step B3, Qᵢ is output as ofrac and eh is output as oexp. That is, out (oexp, ofrac) is output and the process ends. Output out is output to a subsequent processing unit (for example, another operation circuit).

(C) Effects

As described above, according to the operation circuit 11a of the present modification, similar action effects to those of the application example illustrated in FIG. 3 can be obtained.

Furthermore, in the operation circuit 11 illustrated in FIG. 3, one bit of solution is worked out per cycle while i is small, and two bits of solution are worked out per cycle after i has become large, whereas the operation circuit 11a of the present modification always works out two bits per cycle regardless of i. This can make the latency in the solution derivation shorter in the operation circuit 11a of the present modification.

(IV) Others

The disclosed technique is not limited to the embodiment described above, and various modifications may be made without departing from the spirit of the present embodiment. Each of the configurations and processes of the present embodiment can be selected or omitted as needed or may be appropriately combined.

Furthermore, the present embodiment can be implemented and manufactured by those skilled in the art according to the above-described disclosure. For example, in the above-described embodiment, a case where the SRT method or the non-restoring method is used is described, but the present invention is not limited to this example, and may be appropriately changed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing apparatus that computes a square root of a radicand, comprising:
a memory; and
a processor coupled to the memory and configured to:
determine a part of a bit string of a quotient;
calculate a first partial remainder based on the bit string and a partial remainder by performing a first operation other than an exponentiation operation in a partial remainder operation; and
calculate the partial remainder by performing a second operation that includes the exponentiation operation, using the first partial remainder and the bit string.

2. The arithmetic processing apparatus according to claim 1, further comprising
a first register configured to store the bit string, wherein
the processor calculates the partial remainder using the bit string stored in the first register in a preceding cycle in repetitions of operations.

3. The arithmetic processing apparatus according to claim 1, further comprising
a second register configured to store the first partial remainder, wherein
the processor calculates the bit string using the first partial remainder stored in the second register in a preceding cycle.

4. The arithmetic processing apparatus according to claim 1, wherein
the processor
works out a solution by a first number of bits per cycle when a number of repetitions of operations is equal to or less than a predetermined threshold value, and works out a solution by a second number of bits greater than the first number of bits per cycle when the number of repetitions of operations is greater than the threshold value.

5. A control method for an arithmetic processing apparatus that computes a square root of a radicand, the arithmetic processing method comprising:
in the arithmetic processing apparatus,
determining, by a first logic circuit, a part of a bit string of a quotient;
calculating, by a second logic circuit, a first partial remainder based on the bit string and a partial remainder by performing a first operation other than an exponentiation operation in a partial remainder operation; and
calculating, by a third logic circuit, the partial remainder by performing a second operation that includes the exponentiation operation, using the first partial remainder and the bit string.

6. The control method according to claim 5, further comprising:
storing the bit string determined by the first logic circuit in a first register; and
calculating, by the third logic circuit, the partial remainder using the bit string stored in the first register in a preceding cycle in repetitions of operations.

7. The control method according to claim 5, further comprising:
storing the first partial remainder calculated by the second logic circuit in a second register; and
calculating, by the first logic circuit, the bit string using the first partial remainder stored in the second register in a preceding cycle.

8. The control method according to claim 5, further comprising
working, by the first logic circuit, out a solution by a first number of bits per cycle when a number of repetitions of operations is equal to or less than a predetermined threshold value; and
working out a solution by a second number of bits greater than the first number of bits per cycle when the number of repetitions of operations is greater than the threshold value.
